(19) United States
(12) Patent Application Publication
(10) Pub. No.: US 2023/0283901 A1
(43) Pub. Date: Sep. 7, 2023

(54) MEMS Lens / Image Sensor Assembly and Process Flow

(71) Applicant: MEMS DRIVE (NANJING) CO., LTD., NANJING (CN)

(72) Inventors: Xiaolei Liu, South Pasadena, CA (US); Matthew Ng, Rosemead, CA (US); Guiqin Wang, Arcadia, CA (US)

(21) Appl. No.: 18/179,877

(22) Filed: Mar. 7, 2023

Related U.S. Application Data
(60) Provisional application No. 63/317,376, filed on Mar. 7, 2022.

(51) Int. Cl. H04N 23/68; H04N 23/54; H04N 23/55; G02B 26/08

(52) U.S. Cl. CPC H04N 23/687; H04N 23/54; H04N 23/55; G02B 26/0858

(57) ABSTRACT

A MEMS lens/image sensor assembly including: an image sensor subassembly; an image stabilization subassembly affixed to and electrically coupled to the image sensor subassembly; and a lens barrel assembly affixed to the image stabilization assembly.

### RELATED CASE(S)

This application claims the benefit of U.S. Provisional Application No. 63/317,376 filed on 7 Mar. 2022, the contents of which are incorporated herein by reference.

### TECHNICAL FIELD

This disclosure relates to actuators in general and, more particularly, to miniaturized MEMS actuators configured for use within camera packages and methods of making the same.

### BACKGROUND

As is known in the art, actuators may be used to convert electronic signals into mechanical motion. In many applications such as e.g., portable devices, imaging-related devices, telecommunications components, and medical instruments, it may be beneficial for miniature actuators to fit within the small size, low power, and cost constraints of these application.

Micro-electrical-mechanical system (MEMS) technology is the technology that in its most general form may be defined as miniaturized mechanical and electro-mechanical elements that are made using the techniques of microfabrication. The critical dimensions of MEMS devices may vary from well below one micron to several millimeters. In general, MEMS actuators are more compact than conventional actuators, and they consume less power.

### SUMMARY OF DISCLOSURE

In one implementation, a MEMS lens/image sensor assembly including: an image sensor subassembly; an image stabilization subassembly affixed to and electrically coupled to the image sensor subassembly; and a lens barrel assembly affixed to the image stabilization assembly.

One or more of the following features may be included. The image sensor subassembly may include: an optoelectronic device; and a first electrical subsystem electrically coupled to the optoelectronic device and the image stabilization subassembly. The first electrical subsystem may be electrically coupled to the optoelectronic device via a solder reflow process. The first electrical subsystem may be electrically coupled to the image stabilization subassembly via a wire bonding process. The image sensor subassembly may further include: an infrared filter positioned proximate the optoelectronic device. The image sensor subassembly may further include: a support assembly configured to provide impact resistance to the optoelectronic device; and a second electrical subsystem affixed to the support assembly and electrically coupled to the image stabilization subassembly. The second electrical subsystem may be electrically coupled to the image stabilization subassembly via a wire bonding process. The image sensor subassembly may further include: a spacer assembly affixed to the second electrical subsystem. The image stabilization subassembly may be affixed to the spacer assembly of the image sensor subassembly. The image stabilization subassembly may be a PZT-based image stabilization subassembly. The image stabilization subassembly may be affixed to the image sensor subassembly via an epoxy. The lens barrel assembly may be affixed to the image stabilization assembly via an epoxy. The at least one lens assembly within the lens barrel assembly may be manipulatable to effectuate auto focus functionality. A holder assembly may be positioned proximate the lens barrel and affixed to the image stabilization subassembly.

In another implementation, a MEMS lens/image sensor assembly includes: an image sensor subassembly; an image stabilization subassembly affixed to and electrically coupled to the image sensor subassembly, wherein the image stabilization subassembly includes: an optoelectronic device, a first electrical subsystem electrically coupled to the optoelectronic device and the image stabilization subassembly, a support assembly configured to provide impact resistance to the optoelectronic device, and a second electrical subsystem affixed to the support assembly and electrically coupled to the image stabilization subassembly; and a lens barrel assembly affixed to the image stabilization assembly.

One or more of the following features may be included. The image sensor subassembly may further include: an infrared filter positioned proximate the optoelectronic device. The image stabilization subassembly may be a PZT-based image stabilization subassembly. The at least one lens assembly within the lens barrel assembly may be manipulatable to effectuate auto focus functionality. A holder assembly may be positioned proximate the lens barrel and affixed to the image stabilization subassembly.

In another implementation, a method of producing a MEMS lens/image sensor assembly includes: fabricating a first portion of an image sensor subassembly; coupling an image stabilization subassembly to the first portion of the image sensor subassembly to form a partially unified assembly; fabricating a second portion of the image sensor subassembly; coupling the partially unified assembly to the second portion of the image sensor subassembly to form a fully unified assembly; and affixing the lens barrel assembly to the fully unified assembly to form the MEMS lens/image sensor assembly.

One or more of the following features may be included. Fabricating a first portion of an image sensor subassembly may include: electrically coupling a first electrical subsystem and an optoelectronic device included within the first portion of the image sensor subassembly. Fabricating a first portion of an image sensor subassembly further may include: affixing an infrared filter proximate the optoelectronic device. Coupling an image stabilization subassembly to the first portion of the image sensor subassembly to form a partially unified assembly may include: electrically coupling the image stabilization subassembly to the first portion of the image sensor subassembly to form the partially unified assembly. Fabricating a second portion of the image sensor subassembly may include: coupling a support assembly, a second electrical subsystem and a spacer assembly included within the second portion of the image sensor subassembly. Coupling the partially unified assembly to the second portion of the image sensor subassembly to form a fully unified assembly may include: electrically coupling the partially unified assembly to the second portion of the image sensor subassembly to form the fully unified assembly. A holder assembly may be affixed to the fully unified assembly. The image stabilization subassembly may include a PZT-based image stabilization subassembly.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a perspective view of a MEMS package in accordance with various embodiments of the present disclosure;

FIG. 2A is a diagrammatic view of an in-plane MEMS actuator with the optoelectronic device in accordance with various embodiments of the present disclosure;

FIG. 2B is a perspective view of an in-plane MEMS actuator with the optoelectronic device in accordance with various embodiments of the present disclosure;

FIG. 3 is a diagrammatic view of an in-plane MEMS actuator in accordance with various embodiments of the present disclosure;

FIG. 4 is a diagrammatic view of a comb drive sector in accordance with various embodiments of the present disclosure;

FIG. 5 is a diagrammatic view of a comb pair in accordance with various embodiments of the present disclosure;

FIG. 6 is a diagrammatic view of fingers of the comb pair of FIG. 5 in accordance with various embodiments of the present disclosure;

FIGS. 7A-7C are diagrammatic views of a piezoelectric out-of-plane actuator in accordance with various embodiments of the present disclosure;

FIG. 7D is a diagrammatic view of a piezoelectric in-plane actuator in accordance with various embodiments of the present disclosure;

FIG. 8 is a diagrammatic view of a MEMS package in accordance with various embodiments of the present disclosure;

FIG. 9 is a diagrammatic view of a MEMS lens/image sensor assembly in accordance with various embodiments of the present disclosure;

FIGS. 10-10A are diagrammatic views of the MEMS lens/image sensor assembly of FIG. 9 in accordance with various embodiments of the present disclosure;

FIGS. 11-11A are diagrammatic views of the MEMS lens/image sensor assembly of FIG. 9 in accordance with various embodiments of the present disclosure;

FIGS. 12-12A are diagrammatic views of the MEMS lens/image sensor assembly of FIG. 9 in accordance with various embodiments of the present disclosure;

FIGS. 13A-13C are diagrammatic views of the MEMS lens/image sensor assembly of FIGS. 9-12 being actuated in accordance with various embodiments of the present disclosure; and

FIG. 14 is a flowchart of an implementation of a process of manufacturing the MEMS lens/image sensor assembly of FIGS. 9-12 in accordance with various embodiments of the present disclosure.

Like reference symbols in the various drawings indicate like elements.

### DETAILED DESCRIPTION OF THE PREFERRED EMBODIMENTS

### System Overview:

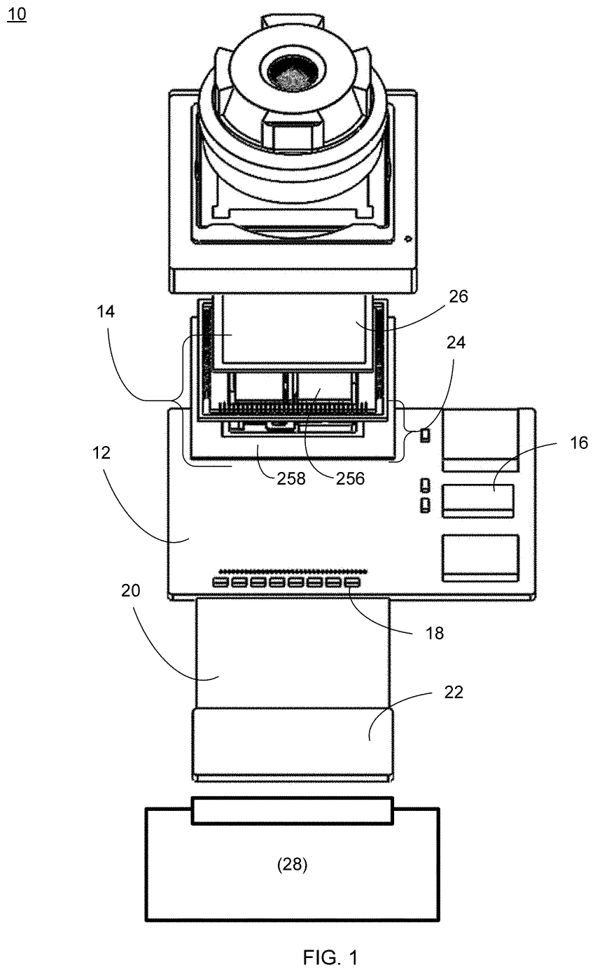

Referring to FIG. 1, there is shown MEMS package 10, in accordance with various aspects of this disclosure. In this example, MEMS package 10 is shown to include printed circuit board 12, multi-axis MEMS assembly 14, driver circuits 16, electronic components 18, flexible circuit 20, and electrical connector 22. Multi-axis MEMS assembly 14 may include micro-electrical-mechanical system (MEMS) actuator 24 (configured to provide linear three-axis movement) and optoelectronic device 26 coupled to micro-electrical-mechanical system (MEMS) actuator 24.

As will be discussed below in greater detail, examples of micro-electrical-mechanical system (MEMS) actuator 24 may include but are not limited to an in-plane MEMS actuator, an out-of-plane MEMS actuator, and a combination in-plane/out-of-plane MEMS actuator. For example and if micro-electrical-mechanical system (MEMS) actuator 24 is an in-plane MEMS actuator, the in-plane MEMS actuator may include an electrostatic comb drive actuation system (as will be discussed below in greater detail). Additionally, if micro-electrical-mechanical system (MEMS) actuator 24 is an out-of-plane MEMS actuator, the out-of-plane MEMS actuator may include a piezoelectric actuation system or electrostatic actuation. And if micro-electrical-mechanical system (MEMS) actuator 24 is a hybrid in-plane/out-of-plane MEMS actuator, the combination in-plane/out-of-plane MEMS actuator may include an electrostatic comb drive actuation system and a piezoelectric actuation system.

As will be discussed below in greater detail, examples of optoelectronic device 26 may include but are not limited to an image sensor, a holder assembly, an IR filter and/or a lens assembly. Examples of electronic components 18 may include but are not limited to various electronic or semiconductor components and devices. Flexible circuit 20 and/or connector 22 may be configured to electrically couple MEMS package 10 to e.g., a smart phone or a digital camera (represented as generic item 28).

In some embodiments, some of the components of MEMS package 10 may be joined together using various epoxies/adhesives. For example, an outer frame of micro-electrical-mechanical system (MEMS) actuator 24 may include contact pads that may correspond to similar contact pads on printed circuit board 12.

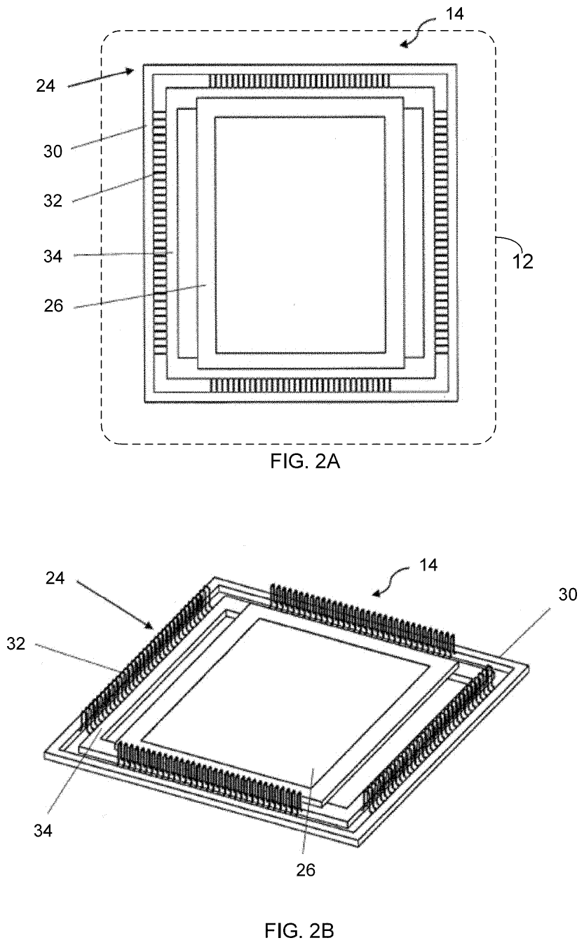

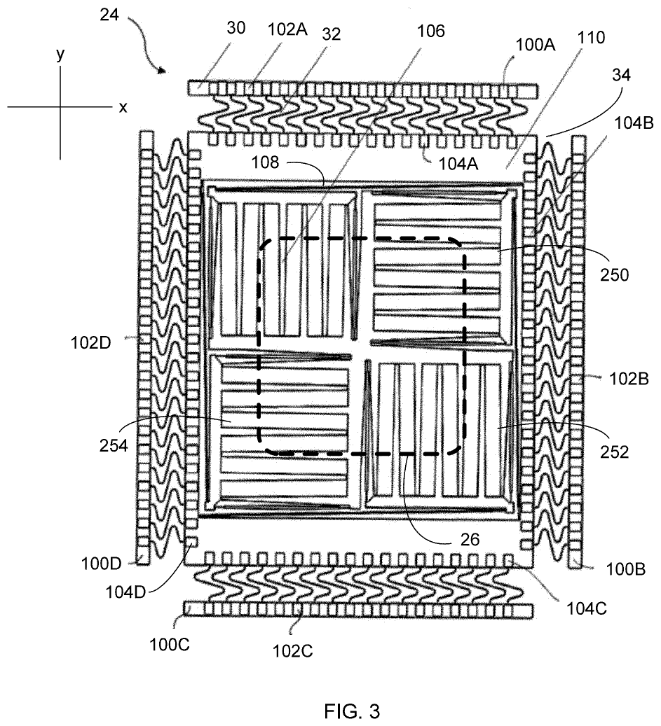

Referring also to FIG. 2A, there is shown multi-axis MEMS assembly 14, which may include optoelectronic device 26 coupled to micro-electrical-mechanical system (MEMS) actuator 24. As discussed above, examples of micro-electrical-mechanical system (MEMS) actuator 24 may include but are not limited to an in-plane MEMS actuator, an out-of-plane MEMS actuator, and a combination in-plane/out-of-plane MEMS actuator.

When configured to provide in-plane actuation functionality, micro-electrical-mechanical system (MEMS) actuator 24 may include outer frame 30, plurality of electrically conductive flexures 32, MEMS actuation core 34 for attaching a payload (e.g., a device), and attached optoelectronic device 26. Optoelectronic device 26 may be coupled to MEMS actuation core 34 of micro-electrical-mechanical system (MEMS) actuator 24 by epoxy (or various other adhesives/materials and/or bonding methods).

Referring also to FIG. 2B, plurality of electrically conductive flexures 32 of micro-electrical-mechanical system (MEMS) actuator 24 may be curved upward and buckled to achieve the desired level of flexibility & compression. In the illustrated embodiment, plurality of electrically conductive flexures 32 may have one end attached to MEMS actuation core 34 (e.g., the moving portion of micro-electrical-mechanical system (MEMS) actuator 24) and the other end attached to outer frame 30 (e.g., the fixed portion of micro-electrical-mechanical system (MEMS) actuator 24).

Plurality of electrically conductive flexures 32 may be conductive wires that may extend above the plane (e.g., an upper surface) of micro-electrical-mechanical system (MEMS) actuator 24 and may electrically couple laterally separated components of micro-electrical-mechanical system (MEMS) actuator 24. For example, plurality of electrically conductive flexures 32 may provide electrical signals from optoelectronic device 26 and/or MEMS actuation core 34 to outer frame 30 of micro-electrical-mechanical system (MEMS) actuator 24. As discussed above, outer frame 30 of micro-electrical-mechanical system (MEMS) actuator 24 may be affixed to circuit board 12 using epoxy (or various other adhesive materials or devices).

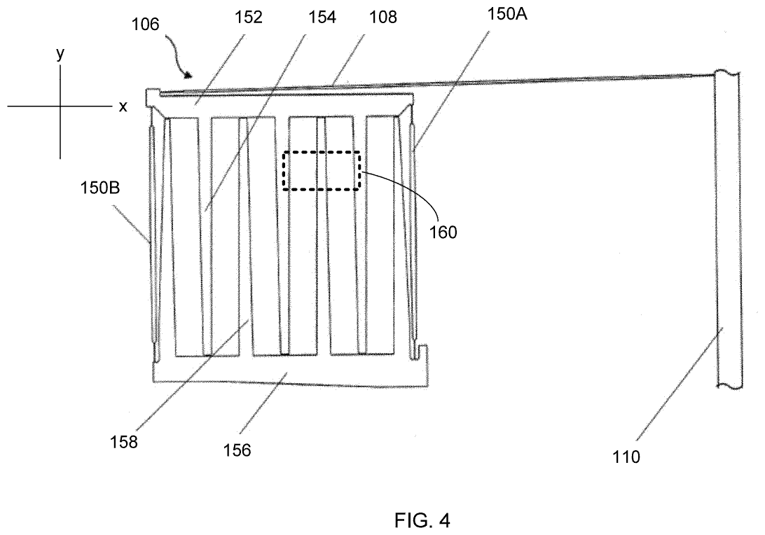

Referring also to FIG. 3, there is shown a top view of micro-electrical-mechanical system (MEMS) actuator 24 in accordance with various embodiments of the disclosure. Outer frame 30 is shown to include (in this example) four frame assemblies (e.g., frame assembly 100A, frame assembly 100B, frame assembly 100C, frame assembly 100D) that are shown as being spaced apart to allow for additional detail.

Outer frame 30 of micro-electrical-mechanical system (MEMS) actuator 24 may include a plurality of contact pads (e.g., contact pads 102A on frame assembly 100A, contact pads 102B on frame assembly 100B, contact pads 102C on frame assembly 100C, and contact pads 102D on frame assembly 100D), which may be electrically coupled to one end of plurality of electrically conductive flexures 32. The curved shape of electrically conductive flexures 32 is provided for illustrative purposes only and, while illustrating one possible embodiment, other configurations are possible and are considered to be within the scope of this disclosure.

MEMS actuation core 34 may include a plurality of contact pads (e.g., contact pads 104A, contact pads 104B, contact pads 104C, contact pads 104D), which may be electrically coupled to the other end of plurality of electrically conductive flexures 32. A portion of the contact pads (e.g., contact pads 104A, contact pads 104B, contact pads 104C, contact pads 104D) of MEMS actuation core 34 may be electrically coupled to optoelectronic device 26 by wire bonding, silver paste, or eutectic seal, thus allowing for the electrical coupling of optoelectronic device 26 to outer frame 30.

### Electrostatic Actuation

MEMS actuation core 34 may include one or more comb drive sectors (e.g., comb drive sector 106) that are actuation sectors disposed within micro-electrical-mechanical system (MEMS) actuator 24. The comb drive sectors (e.g., comb drive sector 106) within MEMS actuation core 34 may be disposed in the same plane and may be positioned orthogonal to each other to allow for movement in two axes (e.g., the X-axis and the Y-axis). Accordingly, the in-plane MEMS actuator generally (and MEMS actuation core 34 specifically) may be configured to provide linear X-axis movement and linear Y-axis movement.

While in this particular example, MEMS actuation core 34 is shown to include four comb drive sectors, this is for illustrative purposes only and is not intended to be a limitation of this disclosure, as other configurations are possible. For example, the number of comb drive sectors may be increased or decreased depending upon design criteria.

While in this particular example, the four comb drive sectors are shown to be generally square in shape, this is for illustrative purposes only and is not intended to be a limitation of this disclosure, as other configurations are possible. For example, the shape of the comb drive sectors may be changed to meet various design criteria.

While the comb drive sectors (e.g., comb drive sector 106) within MEMS actuation core 34 are shown to be positioned orthogonal to each other to allow for movement in two axes (e.g., the X-axis and the Y-axis), this is for illustrative purposes only and is not intended to be a limitation of this disclosure, as other configurations are possible. For example, the comb drive sectors (e.g., comb drive sector 106) within MEMS actuation core 34 may be positioned parallel to each other to allow for movement in a single axis (e.g., either the X-axis or the Y-axis).

Each comb drive sector (e.g., comb drive sector 106) within MEMS actuation core 34 may include one or more moving portions and one or more fixed portions. As will be discussed below in greater detail, a comb drive sector (e.g., comb drive sector 106) within MEMS actuation core 34 may be coupled, via a cantilever assembly (e.g., cantilever assembly 108), to outer periphery 110 of MEMS actuation core 34 (i.e., the portion of MEMS actuation core 34 that includes contact pads 104A, contact pads 104B, contact pads 104C, contact pads 104D), which is the portion of MEMS actuation core 34 to which optoelectronic device 26 may be coupled, thus effectuating the transfer of movement to optoelectronic device 26.

Referring also to FIG. 4, there is shown a top view of comb drive sector 106 in accordance with various embodiments of the present disclosure. Each comb drive sector (e.g., comb drive sector 106) may include one or more motion control cantilever assemblies (e.g., motion control cantilever assemblies 150A, 150B) positioned outside of comb drive sector 106, moveable frame 152, moveable spines 154, fixed frame 156, fixed spines 158, and cantilever assembly 108 that is configured to couple moving frame 152 to outer periphery 110 of MEMS actuation core 34. In this particular configuration, motion control cantilever assemblies 150A, 150B may be configured to prevent Y-axis displacement between moving frame 152/moveable spines 154 and fixed frame 156/fixed spines 158.

Comb drive sector 106 may include a movable member including moveable frame 152 and multiple moveable spines 154 that are generally orthogonal to moveable frame 152. Comb drive sector 106 may also include a fixed member including fixed frame 156 and multiple fixed spines 158 that are generally orthogonal to fixed frame 156. Cantilever assembly 108 may be deformable in one direction (e.g., in response to Y-axis deflective loads) and rigid in another direction (e.g., in response to X-axis tension and compression loads), thus allowing for cantilever assembly 108 to absorb motion in the Y-axis but transfer motion in the X-axis.

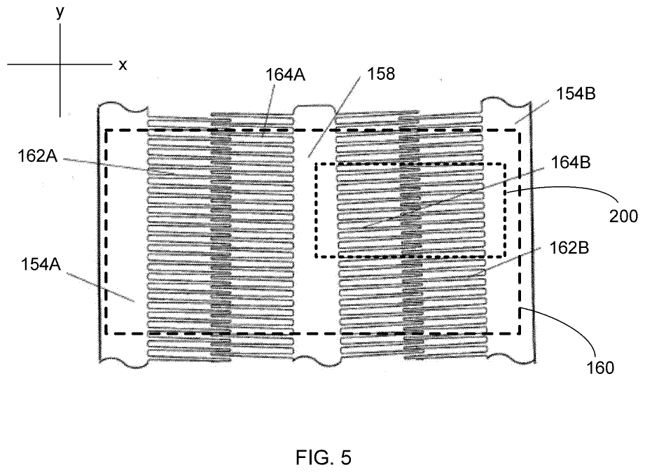

Referring also to FIG. 5, there is shown a detail view of portion 160 of comb drive sector 106. Moveable spines 154A, 154B may include a plurality of discrete moveable actuation fingers that are generally orthogonally-attached to moveable spines 154A, 154B. For example, moveable spine 154A is shown to include moveable actuation fingers 162A and moveable spine 154B is shown to include moveable actuation fingers 162B.

Further, fixed spine 158 may include a plurality of discrete fixed actuation fingers that are generally orthogonally-attached to fixed spine 158. For example, fixed spine 158 is shown to include fixed actuation fingers 164A that are configured to mesh and interact with moveable actuation fingers 162A. Further, fixed spine 158 is shown to include fixed actuation fingers 164B that are configured to mesh and interact with moveable actuation fingers 162B.

Accordingly, various numbers of actuation fingers may be associated with (i.e., coupled to) the moveable spines (e.g., moveable spines 154A, 154B) and/or the fixed spines (e.g., fixed spine 158) of comb drive sector 106. As discussed above, each comb drive sector (e.g., comb drive sector 106) may include two motion control cantilever assemblies 150A, 150B separately placed on each side of comb drive sector 106. Each of the two motion control cantilever assemblies 150A, 150B may be configured to couple moveable frame 152 and fixed frame 156, as this configuration enables moveable actuation fingers 162A, 162B to be displaceable in the X-axis with respect to fixed actuation fingers 164A, 164B (respectively) while preventing moveable actuation fingers 162A, 162B from being displaced in the Y-axis and contacting fixed actuation fingers 164A, 164B (respectively).

While actuation fingers 162A, 162B, 164A, 164B (or at least the center axes of actuation fingers 162A, 162B, 164A, 164B) are shown to be generally parallel to one another and generally orthogonal to the respective spines to which they are coupled, this is for illustrative purposes only and is not intended to be a limitation of this disclosure, as other configurations are possible. Further and in some embodiments, actuation fingers 162A, 162B, 164A, 164B may have the same width throughout their length and in other embodiments, actuation fingers 162A, 162B, 164A, 164B may be tapered.

Further and in some embodiments, moveable frame 152 may be displaced in the positive X-axis direction when a voltage potential is applied between actuation fingers 162A and actuation fingers 164A, while moveable frame 152 may be displaced in the negative X-axis direction when a voltage potential is applied between actuation fingers 162B and actuation fingers 164B.

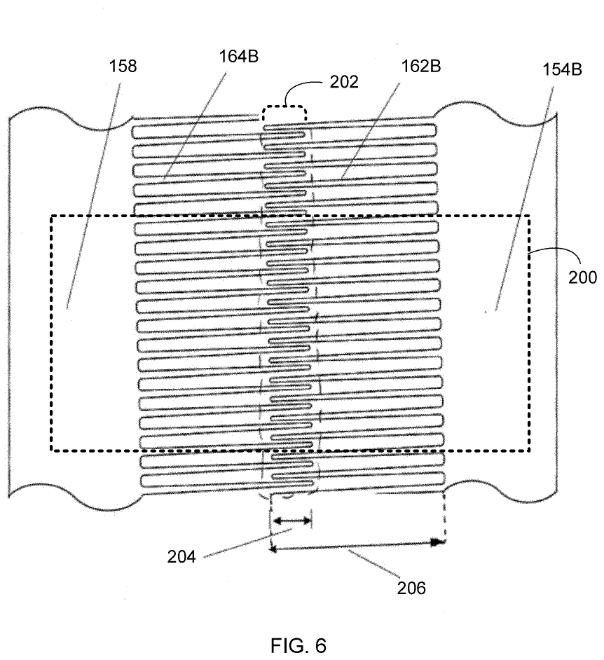

Referring also to FIG. 6, there is shown a detail view of portion 200 of comb drive sector 106. Fixed spine 158 may be generally parallel to moveable spine 154B, wherein actuation fingers 164B and actuation fingers 162B may overlap within region 202, wherein the width of overlap region 202 is typically in the range of 10-50 microns. While overlap region 202 is described as being in the range of 10-50 microns, this is for illustrative purposes only and is not intended to be a limitation of this disclosure, as other configurations are possible.

Overlap region 202 may represent the distance 204 where the ends of actuation fingers 162B extends past and overlap the ends of actuation fingers 164B, which are interposed therebetween. In some embodiments, actuation fingers 162B and actuation fingers 164B may be tapered such that their respective tips are narrower than their respective bases (i.e., where they are attached to their spines). As is known in the art, various degrees of taper may be utilized with respect to actuation fingers 162B and actuation fingers 164B. Additionally, the overlap of actuation fingers 162B and actuation fingers 164B provided by overlap region 202 may help ensure that there is sufficient initial actuation force when an electrical voltage potential is applied so that MEMS actuation core 34 may move gradually and smoothly without any sudden jumps when varying the applied voltage. The height of actuation fingers 162B and actuation fingers 164B may be determined by various aspects of the MEMS fabrication process and various design criteria.

Length 206 of actuation fingers 162B and actuation fingers 164B, the size of overlap region 202, the gaps between adjacent actuation fingers, and actuation finger taper angles that are incorporated into various embodiments may be determined by various design criteria, application considerations, and manufacturability considerations, wherein these measurements may be optimized to achieve the required displacement utilizing the available voltage potential.

As shown in FIG. 3 and as discussed above, MEMS actuation core 34 may include one or more comb drive sectors (e.g., comb drive sector 106), wherein the comb drive sectors (e.g., comb drive sector 106) within MEMS actuation core 34 may be disposed in the same plane and may be positioned orthogonal to each other to allow for movement in two axes (e.g., the X-axis and the Y-axis).

Specifically and in this particular example, MEMS actuation core 34 is shown to include four comb drive sectors (e.g., comb drive sectors 106, 250, 252, 254). As discussed above, comb drive sector 106 is configured to allow for movement along the X-axis, while preventing movement along the Y-axis. As comb drive sector 252 is similarly configured, comb drive sector 252 may allow for movement along the X-axis, while preventing movement along the Y-axis. Accordingly, if a signal is applied to comb drive sector 106 that provides for positive X-axis movement, while a signal is applied to comb drive sector 252 that provides for negative X-axis movement, actuation core 34 may be displaced in a clockwise direction. Conversely, if a signal is applied to comb drive sector 106 that provides for negative X-axis movement, while a signal is applied to comb drive sector 252 that provides for positive X-axis movement, actuation core 34 may be displaced in a counterclockwise direction.

Further, comb drive sectors 250, 254 are configured (in this example) to be orthogonal to comb drive sectors 106, 252. Accordingly, comb drive sectors 250, 254 may be configured to allow for movement along the Y-axis, while preventing movement along the X-axis. Accordingly, if a signal is applied to comb drive sector 250 that provides for positive Y-axis movement, while a signal is applied to comb drive sector 254 that provides for negative Y-axis movement, actuation core 34 may be displaced in a counterclockwise direction. Conversely, if a signal is applied to comb drive sector 250 that provides for negative Y-axis movement, while a signal is applied to comb drive sector 254 that provides for positive Y-axis movement, actuation core 34 may be displaced in a clockwise direction.

Accordingly, the in-plane MEMS actuator generally (and MEMS actuation core 34 specifically) may be configured to provide rotational (e.g., clockwise or counterclockwise) Z-axis movement

### Piezoelectric Actuation

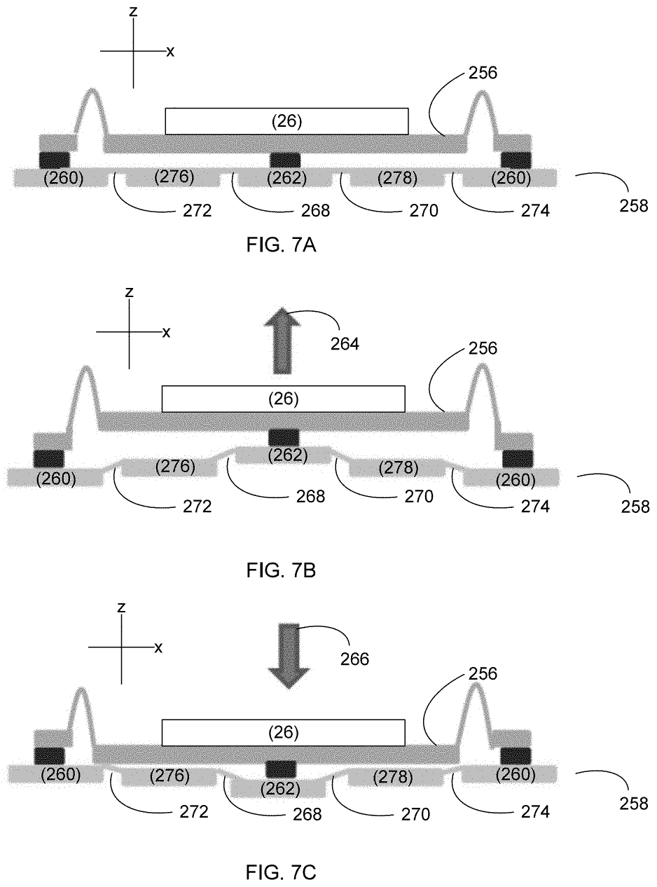

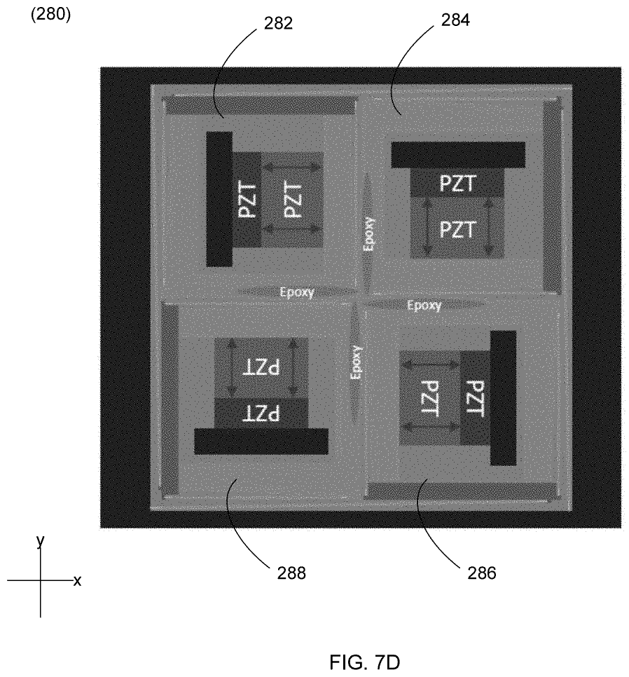

As stated above, examples of micro-electrical-mechanical system (MEMS) actuator 24 may include but are not limited to an in-plane MEMS actuator, an out-of-plane MEMS actuator, and a combination in-plane/out-of-plane MEMS actuator. For example and referring also to FIGS. 7A-7C, micro-electrical-mechanical system (MEMS) actuator 24 is shown to include an in-plane MEMS actuator (e.g., in-plane MEMS actuator 256) and an out-of-plane MEMS actuator (e.g., out-of-plane MEMS actuator 258), wherein FIGS. 3-6 illustrate one possible embodiment of in-plane MEMS actuator 256. Optoelectronic device 26 may be coupled to in-plane MEMS actuator 256; and in-plane MEMS actuator 256 may be coupled to out-of-plane MEMS actuator 258.

An example of in-plane MEMS actuator 256 may include but is not limited to an image stabilization actuator. As is known in the art, image stabilization is a family of techniques that reduce blurring associated with the motion of a camera or other imaging device during exposure. Generally, it compensates for pan and tilt (angular movement, equivalent to yaw and pitch) of the imaging device, though electronic image stabilization may also compensate for rotation. Image stabilization may be used in image-stabilized binoculars, still and video cameras, astronomical telescopes, and smartphones. With still cameras, camera shake may be a particular problem at slow shutter speeds or with long focal length (telephoto or zoom) lenses. With video cameras, camera shake may cause visible frame-to-frame jitter in the recorded video. In astronomy, the problem may be amplified by variations in the atmosphere (which changes the apparent positions of objects over time).

An example of out-of-plane MEMS actuator 258 may include but is not limited to an autofocus actuator. As is known in the art, an autofocus system may use a sensor, a control system and an actuator to focus on an automatically (or manually) selected area. Autofocus methodologies may be distinguished by their type (e.g., active, passive or hybrid). Autofocus systems may rely on one or more sensors to determine correct focus, wherein some autofocus systems may rely on a single sensor while others may use an array of sensors.

FIGS. 7A-7C show one possible embodiment of out-of-plane MEMS actuator 258 in various states of activation/excitation. Out-of-plane MEMS actuator 258 may include frame 260 (which is configured to be stationary) and moveable stage 262, wherein out-of-plane MEMS actuator 258 may be configured to provide linear Z-axis movement. For example, out-of-plane MEMS actuator 258 may include a multi-morph piezoelectric actuator that may be selectively and controllably deformable when an electrical charge is applied, wherein the polarity of the applied electrical charge may vary the direction in which the multi-morph piezoelectric actuator (i.e., out-of-plane MEMS actuator 258) is deformed. For example, FIG. 7A shows out-of-plane MEMS actuator 258 in a natural position without an electrical charge being applied. Further, FIG. 7B shows out-of-plane MEMS actuator 258 in an extended position (i.e., displaced in the direction of arrow 264) with an electrical charge having a first polarity being applied, while FIG. 7C shows out-of-plane MEMS actuator 258 in a retracted position (i.e., displaced in the direction of arrow 266) with an electrical charge having an opposite polarity being applied.

As discussed above, the multi-morph piezoelectric actuator (i.e., out-of-plane MEMS actuator 258) may be deformable by applying an electrical charge. In order to accomplish such deformability that allows for such linear Z-axis movement, the multi-morph piezoelectric actuator (i.e., out-of-plane MEMS actuator 258) may include a bending piezoelectric actuator.

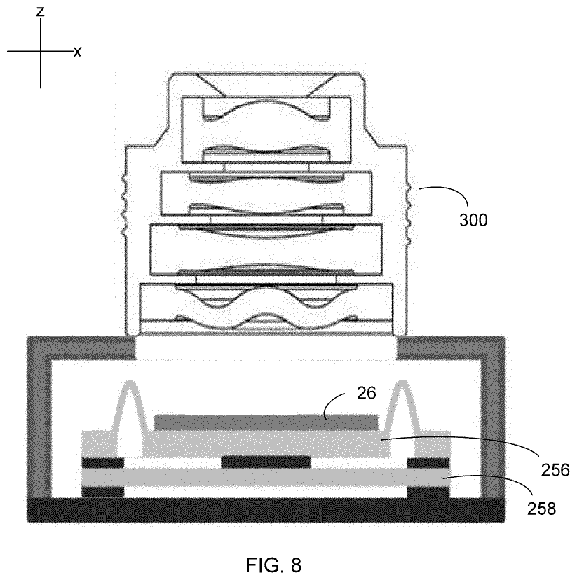

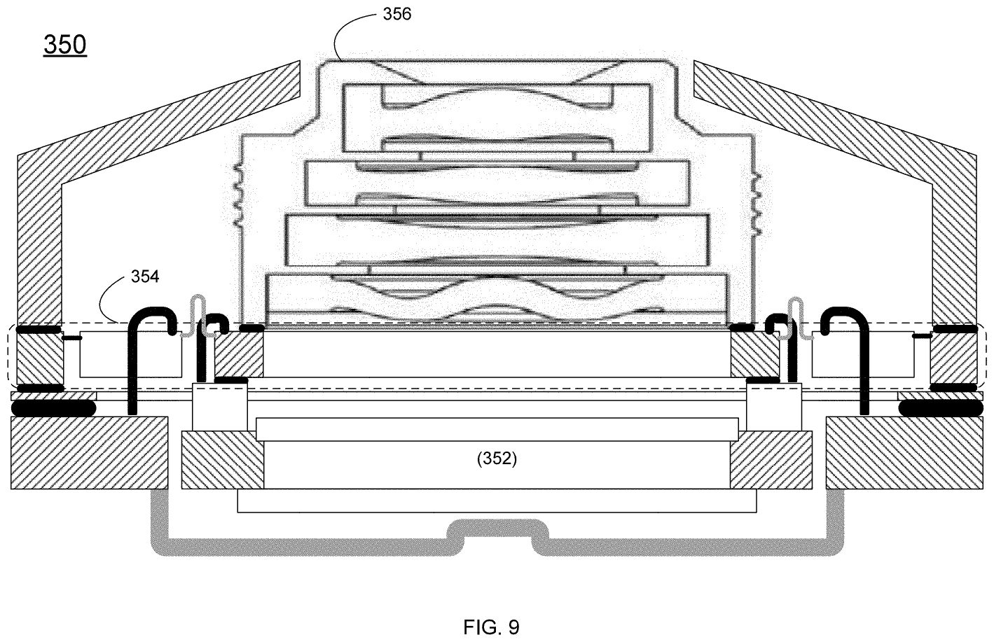

As discussed above, the multi-morph piezoelectric actuator (i.e., out-of-plane MEMS actuator 258) may include rigid frame assembly 260 (which is configured to be stationary) and moveable stage 262 that may be configured to be affixed to in-plane MEMS actuator 256. As discussed above, optoelectronic device 26 may be coupled to in-plane MEMS actuator 256 and in-plane MEMS actuator 256 may be coupled to out-of-plane MEMS actuator 258. Accordingly and when out-of-plane MEMS actuator 258 is in an extended position (i.e., displaced in the direction of arrow 264) with an electrical charge having a first polarity being applied (as shown in FIG. 7B), optoelectronic device 26 may be displaced in the positive z-axis direction and towards a lens assembly (e.g., lens assembly 300, FIG. 8). Alternatively and when out-of-plane MEMS actuator 258 is in a retracted position (i.e., displaced in the direction of arrow 266) with an electrical charge having an opposite polarity being applied (as shown in FIG. 7C), optoelectronic device 26 may be displaced in the negative z-axis direction and away from a lens assembly (e.g., lens assembly 300, FIG. 8). Accordingly and by displacing optoelectronic device 26 in the z-axis with respect to a lens assembly (e.g., lens assembly 300, FIG. 8), autofocus functionality may be achieved.

The multi-morph piezoelectric actuator (i.e., out-of-plane MEMS actuator 258) may include at least one deformable piezoelectric portion (e.g., deformable piezoelectric portions 268, 270, 272, 274) configured to couple moveable stage 262 to rigid frame assembly 260.

For example and in one particular embodiment, multi-morph piezoelectric actuator (i.e., out-of-plane MEMS actuator 258) may include a rigid intermediate stage (e.g., rigid intermediate stages 276, 278). A first deformable piezoelectric portion (e.g., deformable piezoelectric portions 268, 270) may be configured to couple rigid intermediate stage (e.g., rigid intermediate stages 276, 278) to moveable stage 262; and a second deformable piezoelectric portion (e.g., deformable piezoelectric portions 272, 274) may be configured to couple the rigid intermediate stage (e.g., rigid intermediate stages 276, 278) to rigid frame assembly 260.

Linear Z-axis (i.e., out-of-plane) movement of moveable stage 262 of out-of-plane MEMS actuator 258 may be generated due to the deformation of the deformable piezoelectric portion (e.g., deformable piezoelectric portions 268, 270, 272, 274), which may be formed of a piezoelectric material (e.g., PZT (lead zirconate titanate), zinc oxide or other suitable material) that may be configured to deflect in response to an electrical signal. As is known in the art, piezoelectric materials are a special type of ceramic that expands or contracts when an electrical field is applied, thus generating motion and force.

While out-of-plane MEMS actuator 258 is described above as including a single moveable stage (e.g., moveable stage 262) that enables linear movement in the Z-axis, this is for illustrative purposes only and is not intended to be a limitation of this disclosure, as other configurations are possible and are considered to be within the scope of this disclosure. For example, out-of-plane MEMS actuator 258 may be configured to include multiple moveable stages. For example, if deformable piezoelectric portions 272, 274 were configured to be separately controllable, additional degrees of freedom (such as tip and/or tilt) may be achievable. For example and in such a configuration, displacing intermediate stage 276 in an upward direction (i.e., in the direction of arrow 264) while displacing intermediate stage 278 in a downward direction (i.e., in the direction of arrow 266) would result in clockwise rotation of optoelectronic device 26 about the Y-axis; while displacing intermediate stage 276 in a downward direction (i.e., in the direction of arrow 266) while displacing intermediate stage 278 in a upward direction (i.e., in the direction of arrow 264) would result in counterclockwise rotation of optoelectronic device 26 about the Y-axis. Additionally/alternatively, corresponding clockwise and counterclockwise rotation of optoelectronic device 26 about the X-axis may be achieved via additional/alternative intermediate stages.

While FIGS. 7A-7C each show one possible embodiment of an out-of-plane piezoelectric MEMS actuator in various states of activation/excitation, this is for illustrative purposes only and is not intended to be a limitation of this disclosure, as other configurations are possible and are considered to be within the scope of this disclosure. For example and as shown in FIG. 7D, in-plane piezoelectric MEMS actuator 280 may be formed in a fashion similar to that of the above-described in-plane electrostatic MEMS actuators. Accordingly, in-plane piezoelectric MEMS actuator 280 may include a plurality of piezoelectric drive sectors (e.g., piezoelectric drive sectors 282, 284, 286, 288) configured in a similar orthogonal fashion (e.g., piezoelectric drive sectors 282, 286 being configured to enable movement in one axis and piezoelectric drive sectors 284, 288 being configured to enable movement in an orthogonal axis), thus enabling movement in the X-axis and the Y-axis, and rotation about the Z-axis.

### MEMS Lens/Sensor Assembly:

Referring also to FIG. 9, there is shown MEMS lens/image sensor assembly 350. MEMS lens/image sensor assembly 350 may include an image sensor subassembly (e.g., image sensor subassembly 352); an image stabilization subassembly (e.g., image stabilization subassembly 354) affixed to and electrically coupled to the image sensor subassembly (e.g., image sensor subassembly 352); and a lens barrel assembly (e.g., lens barrel assembly 356) affixed to the image stabilization subassembly (e.g., image stabilization subassembly 354).

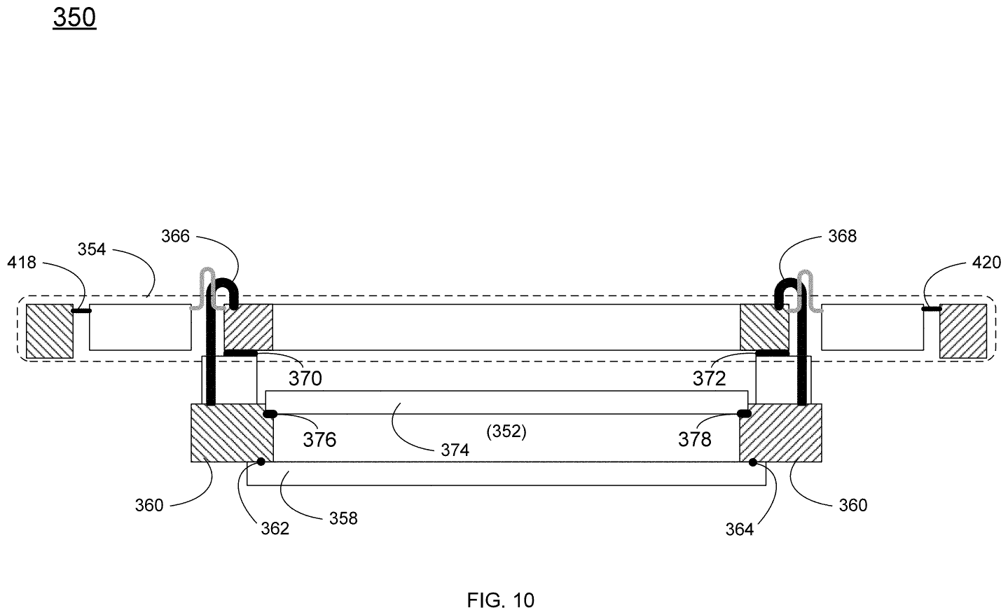

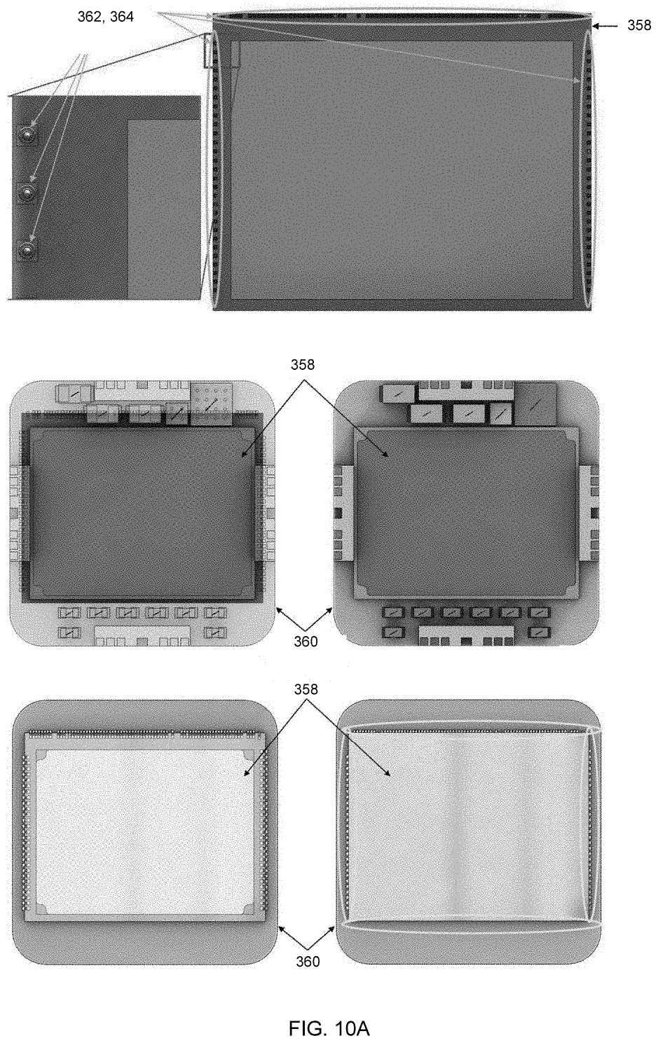

Specifically and referring also to FIGS. 10-10A, the image sensor subassembly (e.g., image sensor subassembly 352) may include: an optoelectronic device (e.g., optoelectronic device 358); and a first electrical subsystem (e.g., first electrical subsystem 360) electrically coupled to the optoelectronic device (e.g., optoelectronic device 358) and the image stabilization subassembly (e.g., image stabilization subassembly 354).

The first electrical subsystem (e.g., first electrical subsystem 360) may be electrically coupled to the optoelectronic device (e.g., optoelectronic device 358) via a solder reflow process. For example, solder beads (e.g., solder beads 362, 364) may be placed onto one of first electrical subsystem 360 and optoelectronic device 358 and a reflow operation may be performed in order to electrically couple first electrical subsystem 360 and optoelectronic device 358.

As is known in the art, reflow soldering is a process in which a solder paste (a sticky mixture of powdered solder and flux) is used to temporarily attach one or thousands of tiny electrical components to their contact pads, after which the entire assembly is subjected to controlled heat. The solder paste reflows in a molten state, creating permanent solder joints. Heating may be accomplished by passing the assembly through a reflow oven, under an infrared lamp, or (unconventionally) by soldering individual joints with a desoldering hot air pencil.

The first electrical subsystem (e.g., first electrical subsystem 360) may be electrically coupled to the image stabilization subassembly (e.g., image stabilization subassembly 354) via a wire bonding process (e.g., via wire-based connections 366, 368). As is known in the art, wire bonding is the method of making interconnections between an integrated circuit (IC) or other semiconductor device and its packaging during semiconductor device fabrication. Although less common, wire bonding can be used to connect an IC to other electronics or to connect from one printed circuit board (PCB) to another. Wire bonding is generally considered the most cost-effective and flexible interconnect technology and is used to assemble the vast majority of semiconductor packages.

The first electrical subsystem (e.g., first electrical subsystem 360) may be physically coupled to the image stabilization subassembly (e.g., image stabilization subassembly 354) via epoxy connections (e.g., epoxy connections 370, 372).

The image sensor subassembly (e.g., image sensor subassembly 352) may include an infrared filter (e.g., infrared filter 374) positioned proximate the optoelectronic device (e.g., optoelectronic device 352). As is known in the art, infrared filters (sometimes called IR filters or heat-absorbing filters) are designed to reflect or block near-infrared wavelengths while passing visible light. They are often used in devices with bright incandescent light bulbs (such as slide and overhead projectors) to prevent unwanted heating. There are also filters which are used in solid state (CCD or CMOS) video cameras to block IR due to the high sensitivity of many camera sensors to near-infrared light. These filters typically have a blue hue to them as they also sometimes block some of the light from the longer red wavelengths.

The image sensor subassembly (e.g., image sensor subassembly 352) may be physically coupled to the infrared filter (e.g., infrared filter 374) via epoxy connections (e.g., epoxy connections 376, 378).

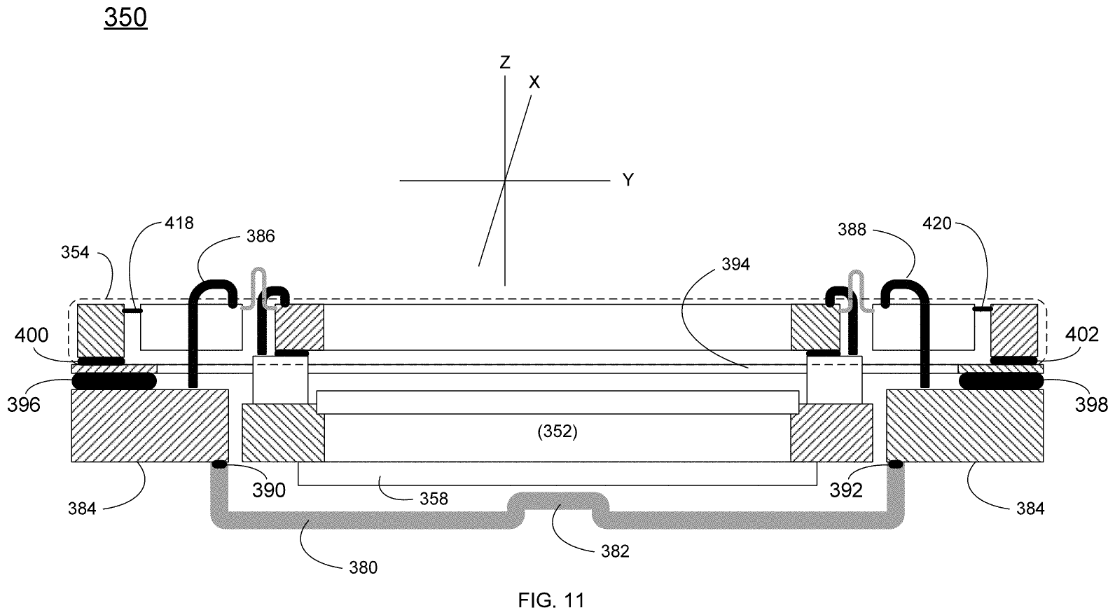

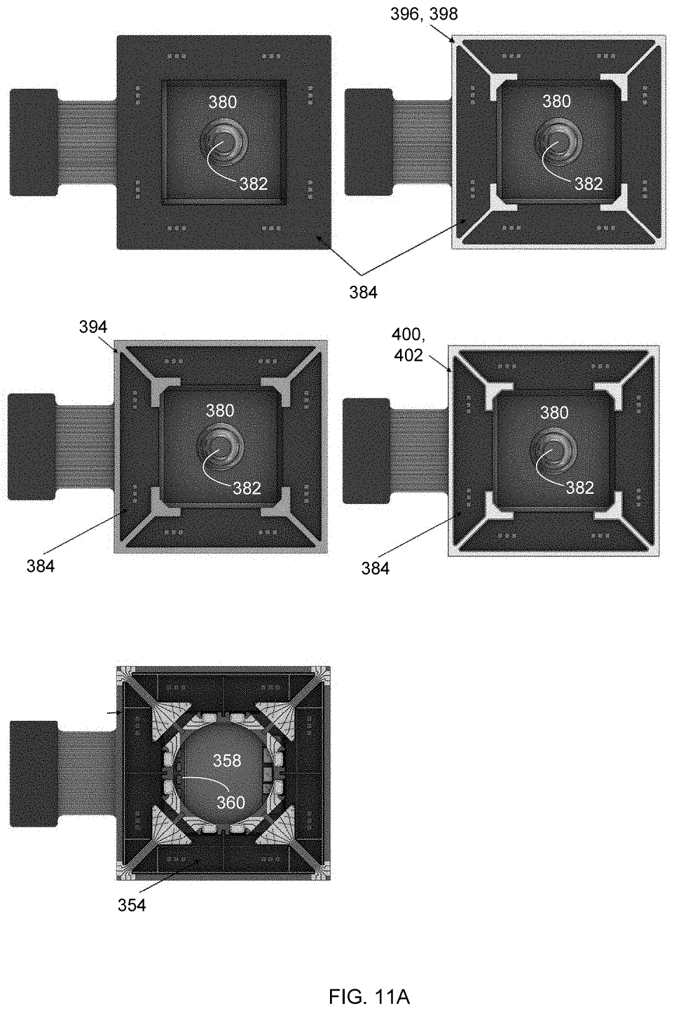

Specifically and referring also to FIGS. 11-11A, the image sensor subassembly (e.g., image sensor subassembly 352) may further include a support assembly (e.g., support assembly 380) configured to provide impact resistance to the optoelectronic device (e.g., optoelectronic device 358). The support assembly (e.g., support assembly 380) may be constructed of material of suitable strength (e.g., metal or plastic) to provide the desired level of rigidity.

Support assembly 380 may include raised center portion 382 configured to be close enough to optoelectronic device 358 to provide the desired level of impact absorption while being far enough away to allow for movement of optoelectronic device 358 (e.g., via rotation about the X-axis and/or Y-axis . . . as will be discussed below in greater detail).

The image sensor subassembly (e.g., image sensor subassembly 352) may further include a second electrical subsystem (e.g., second electrical subsystem 384) affixed to the support assembly (e.g., support assembly 380) and electrically coupled to the image stabilization subassembly (e.g., image stabilization subassembly 354). The second electrical subsystem (e.g., second electrical subsystem 384) may be electrically coupled to the image stabilization subassembly (e.g., image stabilization subassembly 354) via a wire bonding process (e.g., via wire-based connections 386, 388). The support assembly (e.g., support assembly 380) may be physically coupled to the second electrical subsystem (e.g., second electrical subsystem 384) via epoxy connections (e.g., epoxy connections 390, 392).

The image sensor subsystem (e.g., image sensor subassembly 352) may further includes: a spacer assembly (e.g., spacer assembly 394) affixed to the second electrical subsystem (e.g., second electrical subsystem 384). The spacer assembly (e.g., spacer assembly 394) may be physically coupled to the second electrical subsystem (e.g., second electrical subsystem 384) via epoxy connections (e.g., epoxy connections 396, 398). The spacer assembly (e.g., spacer assembly 394) may be constructed of material of suitable strength (e.g., metal or plastic) to provide the desired level of rigidity. The image stabilization subassembly (e.g., image stabilization subassembly 354) may be affixed to the spacer assembly (e.g., spacer assembly 394) of the image sensor subassembly (e.g., image sensor subassembly 352) via epoxy connections (e.g., epoxy connections 400, 402).

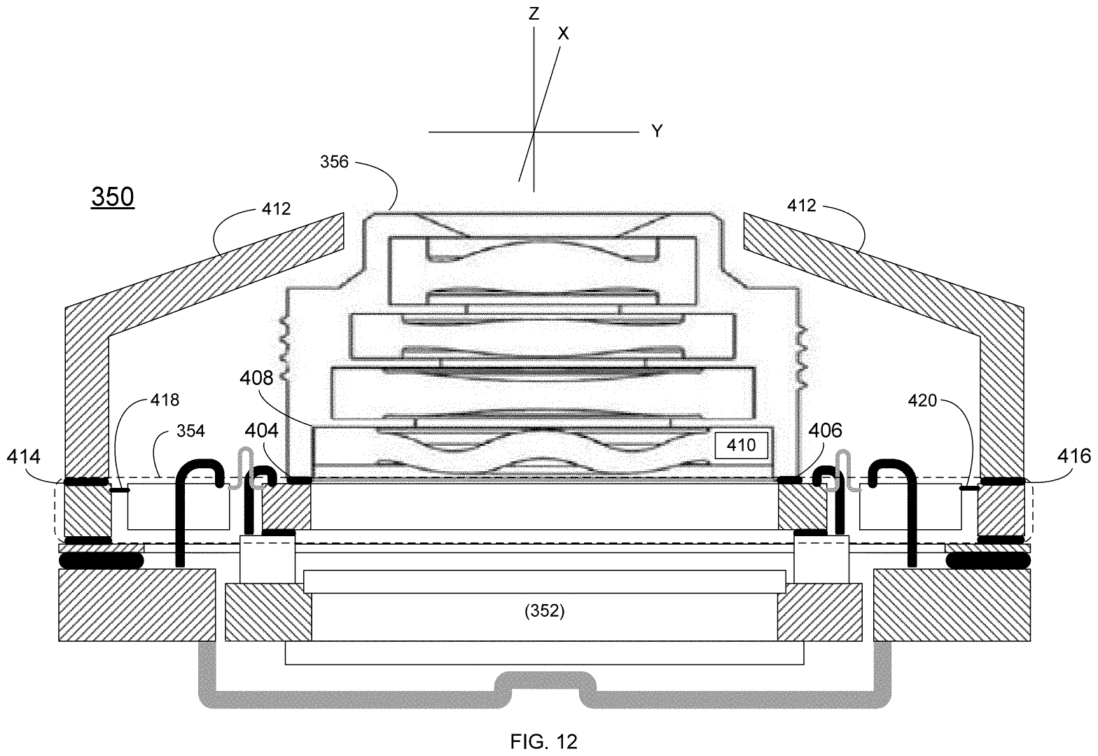

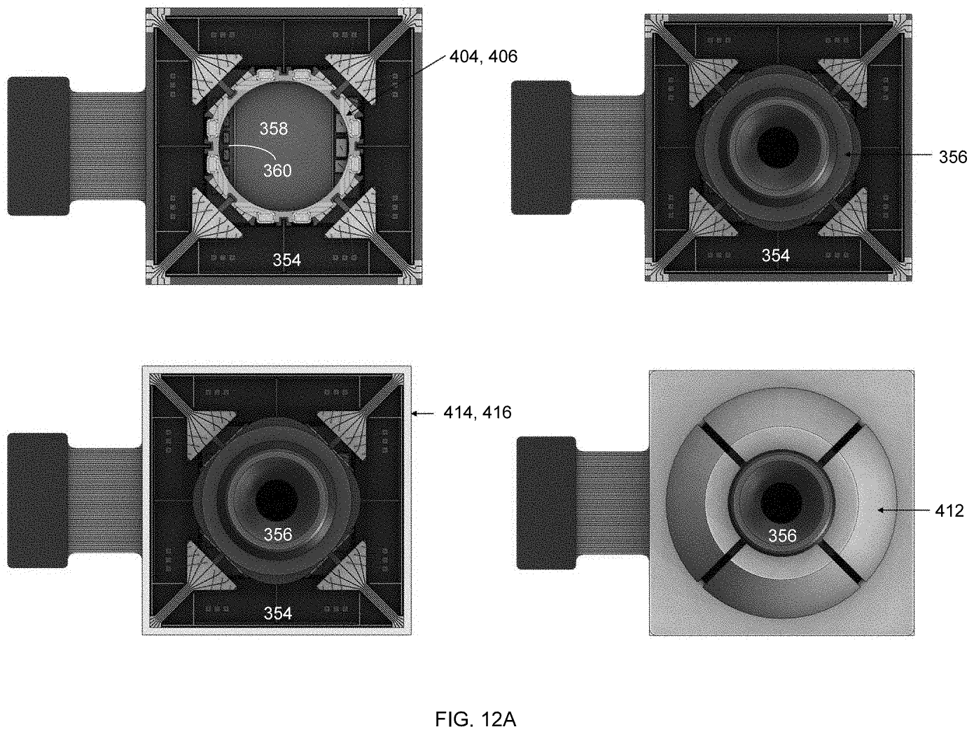

Specifically and referring also to FIGS. 12-12A, the lens barrel assembly (e.g., lens barrel assembly 356) may be affixed to the image stabilization subassembly (e.g., image stabilization subassembly 354) via an epoxy (e.g., epoxy connections 404, 406). At least one lens assembly (e.g., lens assembly 408) within the lens barrel subassembly (e.g., lens barrel assembly 356) may be manipulatable to effectuate auto focus functionality for MEMS lens/image sensor assembly 350. For example, actuator 410 (e.g., a MEMS actuator, a PZT actuator, etc.) may be configured to move the at least one lens assembly (e.g., lens assembly 408) along the Z-axis to vary the focal length of the lens barrel assembly (e.g., lens barrel assembly 356). Additionally/alternatively, actuator 410 (e.g., a MEMS actuator, a PZT actuator, etc.) may be configured to reshape the at least one lens assembly (e.g., lens assembly 408) by changing the concavity/convexity of lens assembly 408 to vary the focal length of the lens barrel assembly (e.g., lens barrel assembly 356).

A holder assembly (e.g., holder assembly 412) may be positioned proximate the lens barrel assembly (e.g., lens barrel assembly 356) and affixed to the image stabilization subassembly (e.g., image stabilization subassembly 354) via epoxy connections (e.g., epoxy connections 414, 416).

The image stabilization subassembly (e.g., image stabilization subassembly 354) may be a PZT-based image stabilization subassembly (e.g., an image stabilization subassembly that is constructed of a piezoelectric material). As is known in the art, a piezoelectric material is a type of material that generates an electric charge in response to an applied mechanical stress or strain. This means that when a piezoelectric material is squeezed or stretched, it produces an electrical charge on its surface. Conversely, when an electrical voltage is applied to a piezoelectric material, the piezoelectric material will deform or change shape. Piezoelectric materials are used in a wide range of applications, including sensors, actuators, and transducers. For example, they are used in pressure sensors to measure changes in pressure, in ultrasound devices to generate and detect sound waves, and in motors to convert electrical energy into mechanical energy. Some common examples of piezoelectric materials include quartz, Rochelle salt, barium titanate, and lead zirconate titanate. Piezoelectric materials have unique properties that make them useful in a variety of applications, and they continue to be an active area of research and development in materials science and engineering.

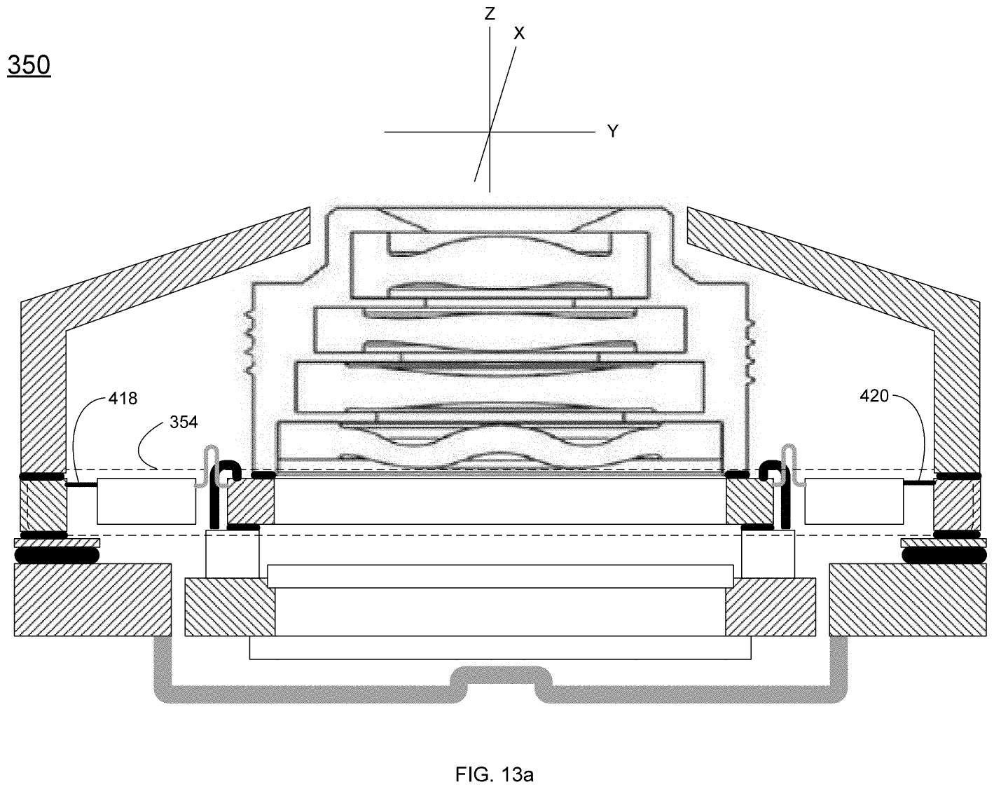

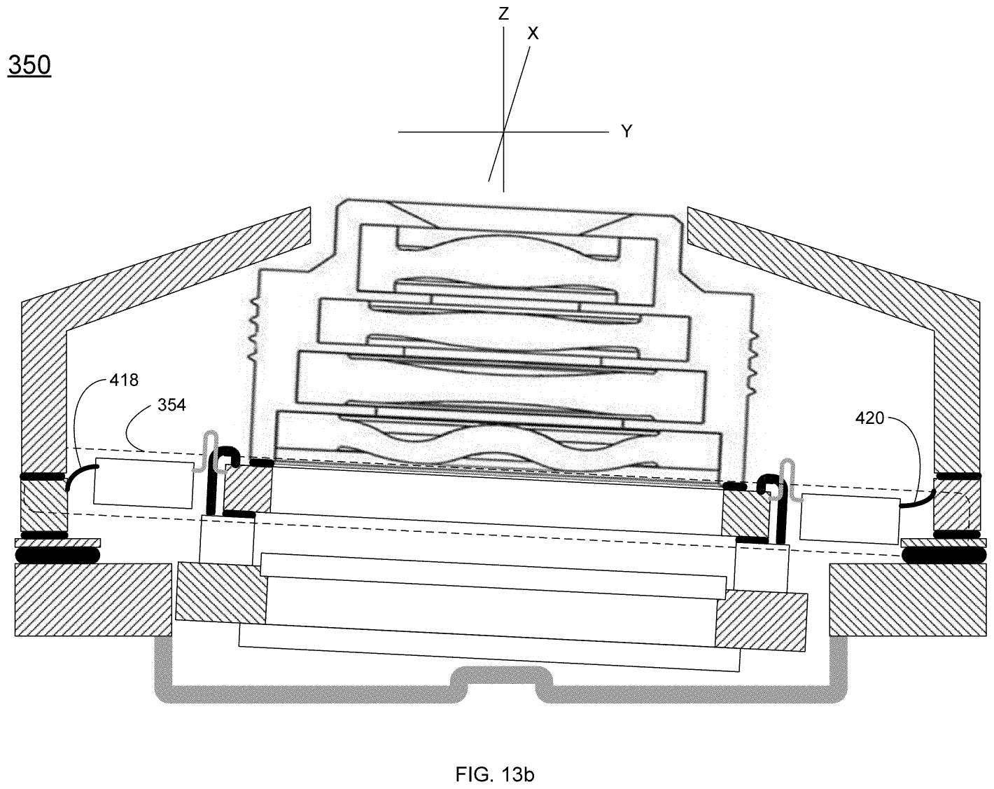

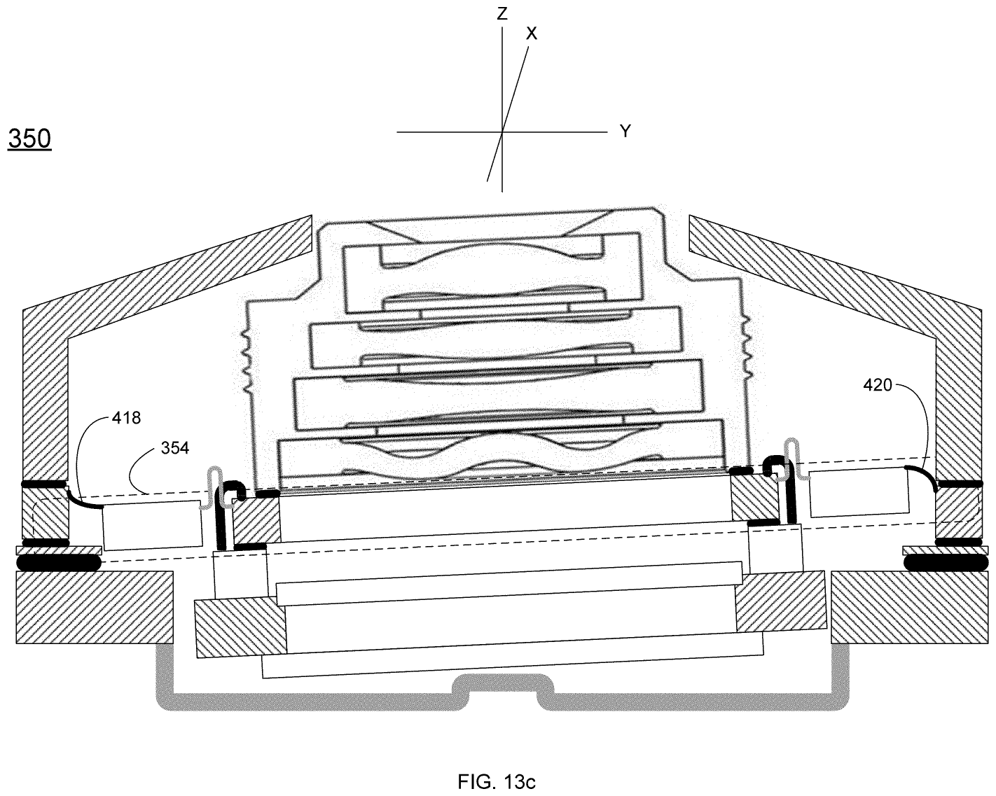

For example and referring also to FIGS. 13A-13C, image stabilization subassembly 354 may include one or more deformable piezoelectric portion (e.g., deformable piezoelectric portions 418, 420) configured to couple a rigid outer frame of image stabilization subassembly 354 to a moveable inner portion of image stabilization subassembly 354. In this particular example, deformable piezoelectric portions 418, 420 are configured to effectuation rotation about the X-axis. However, it is understood that deformable piezoelectric portions 418, 420 may be configured to effectuate rotation about the Y-axis and additional deformable piezoelectric portions may be configured to effectuate rotation about both the X-axis and Y-axis.
Specifically and as shown in FIG. 13A, if no voltage potential is applied to deformable piezoelectric portions 418, 420, no rotation about the X-axis may be effectuated.
Further and as shown in FIG. 13B, if a voltage potential having a first polarity is applied to deformable piezoelectric portions 418, 420, clockwise rotation about the X-axis may be effectuated.
Additionally and as shown in FIG. 13C, if a voltage potential having a second (and opposite) polarity is applied to deformable piezoelectric portions 418, 420, counterclockwise rotation about the X-axis may be effectuated.

### Process Flow:

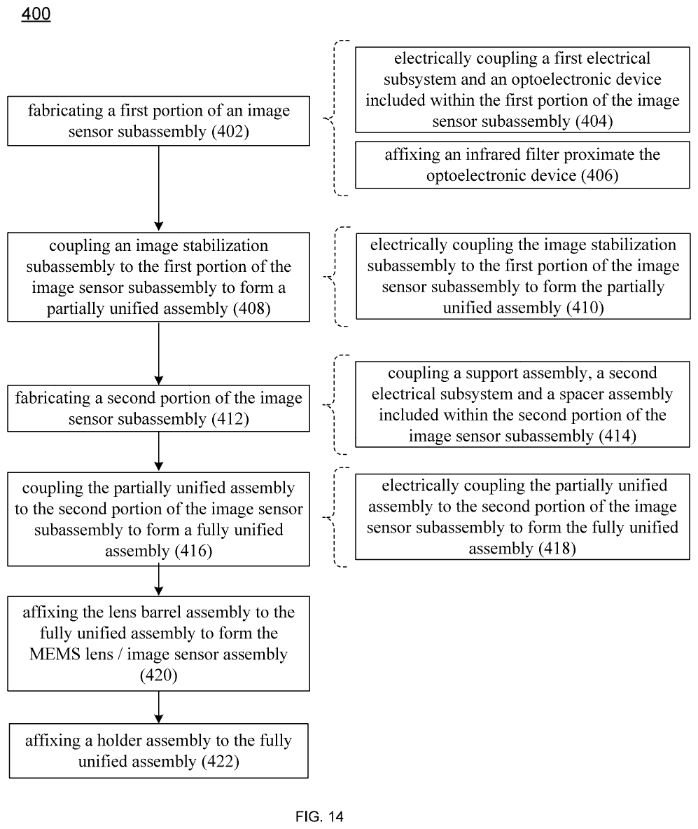

Referring also to FIG. 14, there is shown a method (e.g., method 400) of producing MEMS lens/image sensor assembly 350.

Method 400 may include fabricating 402 a first portion of the image sensor subassembly (e.g., image sensor subassembly 352). For example and when fabricating 402 a first portion of an image sensor subassembly (e.g., image sensor subassembly 352), method 400 may electrically couple 404 a first electrical subsystem (e.g., first electrical subsystem 360) and an optoelectronic device (e.g., optoelectronic device 358) included within the first portion of the image sensor subassembly (e.g., image sensor subassembly 352). Further and when fabricating 402 a first portion of an image sensor subassembly (e.g., image sensor subassembly 352), method 400 may affix 406 an infrared filter (e.g., infrared filter 374) proximate the optoelectronic device (e.g., optoelectronic device 358).

Method 400 may include coupling 408 an image stabilization subassembly (e.g., image stabilization subassembly 354) to the first portion of the image sensor subassembly (e.g., image sensor subassembly 352) to form a partially unified assembly (e.g., the combination of image stabilization subassembly 354, optoelectronic device 358, first electrical subsystem 360 and infrared filter 374).

When coupling 408 an image stabilization subassembly (e.g., image stabilization subassembly 354) to the first portion of the image sensor subassembly (e.g., image sensor subassembly 352) to form a partially unified assembly (e.g., the combination of image stabilization subassembly 354, optoelectronic device 358, first electrical subsystem 360 and infrared filter 374), method 400 may electrically couple 410 the image stabilization subassembly (e.g., image stabilization subassembly 354) to the first portion (e.g., the combination of optoelectronic device 358, first electrical subsystem 360 and infrared filter 374) of the image sensor subassembly (e.g., image sensor subassembly 352) to form the partially unified assembly (e.g., the combination of image stabilization subassembly 354, optoelectronic device 358, first electrical subsystem 360 and infrared filter 374).

Method 400 may include fabricating 412 a second portion of the image sensor subassembly (e.g., image sensor subassembly 352). For example and when fabricating 412 a second portion of the image sensor subassembly (e.g., image sensor subassembly 352), method 400 may couple 414 a support assembly (e.g., support assembly 380), a second electrical subsystem (e.g., second electrical subsystem 384) and a spacer assembly (e.g., spacer assembly 394) included within the second portion of the image sensor subassembly (e.g., image sensor subassembly 352).

Method 400 may include coupling 416 the partially unified assembly (e.g., the combination of image stabilization subassembly 354, optoelectronic device 358, first electrical subsystem 360 and infrared filter 374) to the second portion (e.g., the combination of support assembly 380, second electrical subsystem 384 and spacer assembly 394) of the image sensor subassembly (e.g., image sensor subassembly 352) to form a fully unified assembly (e.g., the combination of image stabilization subassembly 354, optoelectronic device 358, first electrical subsystem 360, infrared filter 374, support assembly 380, second electrical subsystem 384 and spacer assembly 394).

When coupling 416 the partially unified assembly (e.g., the combination of image stabilization subassembly 354, optoelectronic device 358, first electrical subsystem 360 and infrared filter 374) to the second portion (e.g., the combination of support assembly 380, second electrical subsystem 384 and spacer assembly 394) of the image sensor subassembly (e.g., image sensor subassembly 352) to form a fully unified assembly (e.g., the combination of image stabilization subassembly 354, optoelectronic device 358, first electrical subsystem 360, infrared filter 374, support assembly 380, second electrical subsystem 384 and spacer assembly 394), method 400 may electrically couple 418 the partially unified assembly (e.g., the combination of image stabilization subassembly 354, optoelectronic device 358, first electrical subsystem 360 and infrared filter 374) to the second portion (e.g., the combination of support assembly 380, second electrical subsystem 384 and spacer assembly 394) of the image sensor subassembly (e.g., image sensor subassembly 352) to form the fully unified assembly (e.g., the combination of image stabilization subassembly 354, optoelectronic device 358, first electrical subsystem 360, infrared filter 374, support assembly 380, second electrical subsystem 384 and spacer assembly 394).

Method 400 may include affixing 420 the lens barrel assembly (e.g., lens barrel assembly 356) to the fully unified assembly (e.g., the combination of image stabilization subassembly 354, optoelectronic device 358, first electrical subsystem 360, infrared filter 374, support assembly 380, second electrical subsystem 384 and spacer assembly 394) to form MEMS lens/image sensor assembly 350.

Method 400 may include affixing 422 a holder assembly (e.g., holder assembly 412) to the fully unified assembly (e.g., the combination of image stabilization subassembly 354, optoelectronic device 358, first electrical subsystem 360, infrared filter 374, support assembly 380, second electrical subsystem 384 and spacer assembly 394).

### General:

In general, the various operations of method described herein may be accomplished using or may pertain to components or features of the various systems and/or apparatus with their respective components and subcomponents, described herein.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of example block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various example embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described example embodiments, and it will be understood by those skilled in the art that various changes and modifications to the previous descriptions may be made within the scope of the claims.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A MEMS lens/image sensor assembly comprising:
an image sensor subassembly;
an image stabilization subassembly affixed to and electrically coupled to the image sensor subassembly; and
a lens barrel assembly affixed to the image stabilization assembly.

2. The MEMS lens/image sensor assembly of claim 1 wherein the image sensor subassembly includes:
an optoelectronic device; and
a first electrical subsystem electrically coupled to the optoelectronic device and the image stabilization subassembly.

3. The MEMS lens/image sensor assembly of claim 2 wherein the first electrical subsystem is electrically coupled to the optoelectronic device via a solder reflow process.

4. The MEMS lens/image sensor assembly of claim 2 wherein the first electrical subsystem is electrically coupled to the image stabilization subassembly via a wire bonding process.

5. The MEMS lens/image sensor assembly of claim 2 wherein the image sensor subassembly further includes:
an infrared filter positioned proximate the optoelectronic device.

6. The MEMS lens/image sensor assembly of claim 2 wherein the image sensor subassembly further includes:
a support assembly configured to provide impact resistance to the optoelectronic device; and
a second electrical subsystem affixed to the support assembly and electrically coupled to the image stabilization subassembly.

7. The MEMS lens/image sensor assembly of claim 6 wherein the second electrical subsystem is electrically coupled to the image stabilization subassembly via a wire bonding process.

8. The MEMS lens/image sensor assembly of claim 6 wherein the image sensor subassembly further includes:
a spacer assembly affixed to the second electrical subsystem.

9. The MEMS lens/image sensor assembly of claim 8 wherein the image stabilization subassembly is affixed to the spacer assembly of the image sensor subassembly.

10. The MEMS lens/image sensor assembly of claim 1 wherein the image stabilization subassembly is a PZT-based image stabilization subassembly.

11. The MEMS lens/image sensor assembly of claim 1 wherein the image stabilization subassembly is affixed to the image sensor subassembly via an epoxy.

12. The MEMS lens/image sensor assembly of claim 1 wherein the lens barrel assembly is affixed to the image stabilization assembly via an epoxy.

13. The MEMS lens/image sensor assembly of claim 1 wherein at least one lens assembly within the lens barrel assembly is manipulatable to effectuate auto focus functionality.

14. The MEMS lens/image sensor assembly of claim 1 further comprising:
a holder assembly positioned proximate the lens barrel and affixed to the image stabilization subassembly.

15. A MEMS lens/image sensor assembly comprising:
an image sensor subassembly;
an image stabilization subassembly affixed to and electrically coupled to the image sensor subassembly, wherein the image stabilization subassembly includes:
an optoelectronic device,
a first electrical subsystem electrically coupled to the optoelectronic device and the image stabilization subassembly,
a support assembly configured to provide impact resistance to the optoelectronic device, and
a second electrical subsystem affixed to the support assembly and electrically coupled to the image stabilization subassembly; and
a lens barrel assembly affixed to the image stabilization assembly.

16. The MEMS lens/image sensor assembly of claim 15 wherein the image sensor subassembly further includes:
an infrared red filter positioned proximate the optoelectronic device.

17. The MEMS lens/image sensor assembly of claim 15 wherein the image stabilization subassembly is a PZT-based image stabilization subassembly.

18. The MEMS lens/image sensor assembly of claim 15 wherein at least one lens assembly within the lens barrel assembly is manipulatable to effectuate auto focus functionality.

19. The MEMS lens/image sensor assembly of claim 15 further comprising:
a holder assembly positioned proximate the lens barrel and affixed to the image stabilization subassembly.

20. A method of producing a MEMS lens/image sensor assembly comprising:
fabricating a first portion of an image sensor subassembly;
coupling an image stabilization subassembly to the first portion of the image sensor subassembly to form a partially unified assembly;
fabricating a second portion of the image sensor subassembly;
coupling the partially unified assembly to the second portion of the image sensor subassembly to form a fully unified assembly; and
affixing the lens barrel assembly to the fully unified assembly to form the MEMS lens/image sensor assembly.

21. The method of producing a MEMS lens/image sensor assembly of claim 20 wherein fabricating a first portion of an image sensor subassembly includes:
electrically coupling a first electrical subsystem and an optoelectronic device included within the first portion of the image sensor subassembly.

22. The method of producing a MEMS lens/image sensor assembly of claim 21 wherein fabricating a first portion of an image sensor subassembly further includes:
affixing an infrared filter proximate the optoelectronic device.

23. The method of producing a MEMS lens/image sensor assembly of claim 20 wherein coupling an image stabilization subassembly to the first portion of the image sensor subassembly to form a partially unified assembly includes:
electrically coupling the image stabilization subassembly to the first portion of the image sensor subassembly to form the partially unified assembly.

24. The method of producing a MEMS lens/image sensor assembly of claim 20 wherein fabricating a second portion of the image sensor subassembly includes:
coupling a support assembly, a second electrical subsystem and a spacer assembly included within the second portion of the image sensor subassembly.

25. The method of producing a MEMS lens/image sensor assembly of claim 20 wherein coupling the partially unified assembly to the second portion of the image sensor subassembly to form a fully unified assembly includes:
electrically coupling the partially unified assembly to the second portion of the image sensor subassembly to form the fully unified assembly.

26. The method of producing a MEMS lens/image sensor assembly of claim 20 further comprising:
affixing a holder assembly to the fully unified assembly.

27. The method of producing a MEMS lens/image sensor assembly of claim 20 wherein the image stabilization subassembly includes a PZT-based image stabilization subassembly.
